(19) United States
(12) Patent Application Publication
(10) Pub. No.: US 2020/0037806 A1
(43) Pub. Date: Feb. 6, 2020

(54) ELECTRIC KETTLE WITH BASE

(71) Applicant: Sahara Electronics Ltd., Tel Aviv (IL)

(72) Inventor: Shahram Farhamandfar, Holon (IL)

(73) Assignee: Sahara Electronics Ltd., Tel Aviv (IL)

(21) Appl. No.: 16/052,795

(22) Filed: Aug. 2, 2018

(51) Int. Cl. A47J 27/21

(52) U.S. Cl. CPC A47J 27/21058; A47J 27/21191; A47J 27/21175

(57) ABSTRACT

A kettle includes a receptacle, a handle, a cover and a spout, an electrical heating device configured to heat liquid in the receptacle, a switch for operating the electrical heating device, and a controller in electrical communication with the electrical heating device and the switch. The controller cooperates with a temperature sensor to control a temperature of the liquid. An electric base includes electrical components that are in electrical connection with the electrical heating device for providing electrical power to the electrical heating device for heating the liquid. A locking device is located on the receptacle and is movable between an unlocked position and a locked position to lock and unlock the receptacle to and from the base.

### FIELD OF THE INVENTION

The present invention generally relates to electric kettles and more particularly to an electric kettle that locks to its electric base.

### BACKGROUND OF THE INVENTION

Electric kettles, which may or may not be cordless, are well known. In general, the kettle has a power supply base that includes electrical connections suitable for being connected to an external electrical source. The kettle (receptacle) includes a container suitable for containing the liquid to be heated, an electrical heating device suitable for heating the liquid in the container, and complementary electrical connections that are suitable, when the receptacle is placed on the power supply base, for cooperating with the electrical connections of the base and supplying electrical power to the heating device. Typically a controller is provided in the kettle for controlling the electrical power supply of the electrical heating device, which may include a switch movable between an open position and a closed position.

In such a kettle, the assembly providing electric power to the heating device and the control of the electrical power is arranged between the power supply base and the receptacle, and the control means are arranged on the receptacle.

### SUMMARY OF THE INVENTION

The present invention seeks to provide a novel and improved electric kettle that locks to its electric base, as described in detail below.

There is thus provided in accordance with a non-limiting embodiment of the present invention a kettle including a receptacle for holding therein a liquid, a handle, a cover and a spout, an electrical heating device configured to heat liquid in the receptacle, a switch for operating the electrical heating device, a controller in electrical communication with the electrical heating device and the switch, the controller cooperating with a temperature sensor to control a temperature of the liquid, an electric base that includes electrical components that are in electrical connection with the electrical heating device for providing electrical power to the electrical heating device for heating the liquid, and a locking device located on the receptacle and movable between an unlocked position and a locked position to lock and unlock the receptacle to and from the base.

In accordance with a non-limiting embodiment of the invention the locking device is separate from the electrical connection between the receptacle and the base.

In accordance with a non-limiting embodiment of the invention the locking device includes a tongue that extends from a toggle handle, the toggle handle being arranged to slide or move in a slot formed in the receptacle.

In accordance with a non-limiting embodiment of the invention the tongue is arranged to move in or out of locking engagement with the switch.

In accordance with a non-limiting embodiment of the invention the toggle handle is movable between ends of the slot so as to move between the locked and unlocked positions.

In accordance with a non-limiting embodiment of the invention the kettle includes a Sabbath mode of operation wherein the receptacle is in the locked position and cannot be lifted off the base and heating elements of the receptacle and the electronic components of the base are not exposed and the switch cannot be operated.

### BRIEF DESCRIPTION OF THE DRAWINGS

The present invention will be understood and appreciated more fully from the following detailed description, taken in conjunction with the drawings in which:

FIGS. 1 and 2 are simplified perspective and top-view illustrations, respectively, of an electric kettle disposed on an electric base, constructed and operative in accordance with a non-limiting embodiment of the present invention; and

FIGS. 3 and 4 are simplified pictorial and top-view illustrations, respectively, of a bottom portion of the kettle, showing a locking device that locks the kettle to its electric base.

### DETAILED DESCRIPTION OF EMBODIMENTS

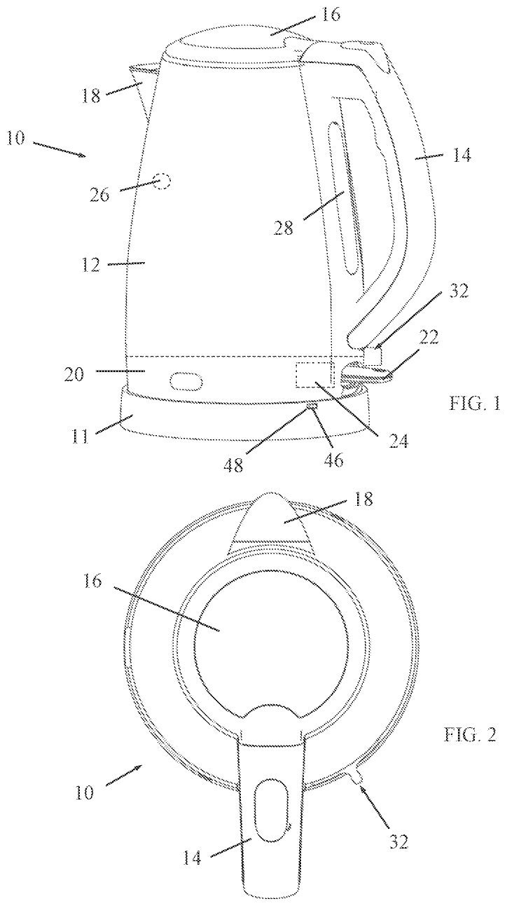

Reference is now made to FIGS. 1 and 2, which illustrate an electric kettle 10 disposed on an electric base 11, constructed and operative in accordance with a non-limiting embodiment of the present invention.

The kettle 10 may include a receptacle 12 for holding therein a liquid (such as water), a handle 14, a cover 16 (which may be hinged) and a spout 18. Kettle 10 further includes an electrical heating device 20 configured to heat the liquid in receptacle 12 to the boiling point. A switch 22 may be provided for operating electrical heating device 20. A controller 24 may be in electrical communication with electrical heating device 20 and switch 22. Controller 24 works with a temperature sensor 26, such that when the desired temperature of the heated liquid is reached (typically, but not necessarily, the boiling point of the liquid), controller 24 turns switch 22 to the off position to cease heating the liquid. A liquid level indicator 28 may be provided to indicate the level of liquid in receptacle 12.

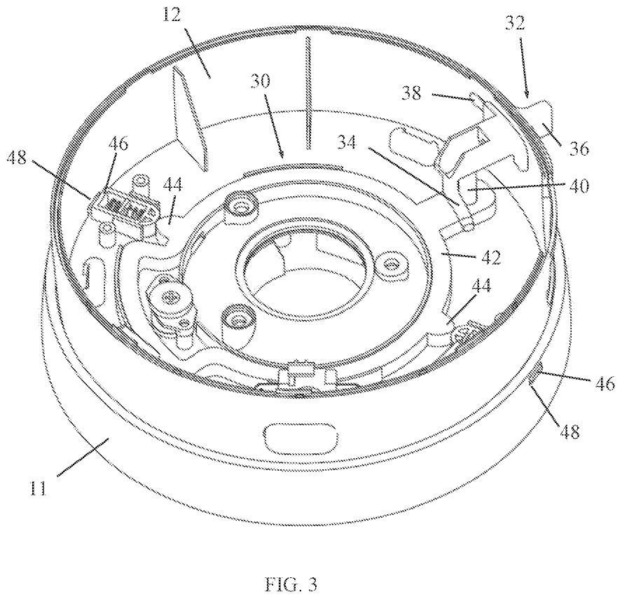

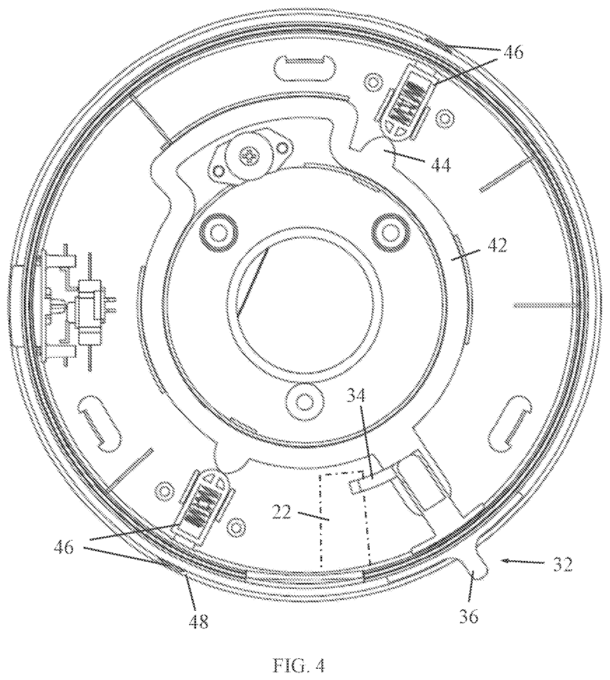

Reference is now made to FIGS. 3 and 4. The electric base 11 includes various electrical components (collectively designated by numeral 30) that electrically communicate with electrical heating device 20 for providing electrical power to heating device 20 for heating the liquid, as is well known in the art. The electric base 11 may include a power cord for connection to mains or may include one or more batteries for cordless operation.

In accordance with a non-limiting embodiment of the present invention, kettle 10 includes a locking device 32 on receptacle 12 for locking the receptacle 12 to the base 11. In a preferred embodiment, the locking device 32 is mechanical but it may be optionally electromechanical or electronic. The locking device 32 is separate from the electrical connection between the receptacle 12 and the base 11. In one embodiment, even if the locking device 32 is electromechanical or electronic, it has nothing to do with the electrical operation of the kettle 10.

In the illustrated embodiment, the locking device 32 includes a tongue 34 that extends from a toggle handle 36 and a lug 40 that is coupled with a cam ring 42. The toggle handle 36 is arranged to slide or move in a slot 38 formed in the receptacle 12.

Cam ring 42 is formed with one or more camming surfaces 44; in the illustrated embodiment there are two diametrically opposed camming surfaces 44. When toggle handle 36 is moved in slot 38, lug 40 also moves sideways (that is, in the circumferential direction) and causes cam ring 42 to rotate. The rotation of cam ring 42 causes camming surfaces 44 to push against spring-loaded locking elements 46 so that locking elements 46 protrude out of receptacle 12 through apertures 48 formed in base 11. (There is the same number of locking elements 46 and apertures 48 as there are camming surfaces 44.) Once locking elements 46 protrude out of receptacle 12 through apertures 48 of base 11, receptacle is locked together with base 11. In the locked position (FIGS. 3-4), lifting receptacle 12 will cause base 11 to be lifted together with receptacle 12. In the unlocked position, the locking elements 46 are not received in apertures 48 so receptacle 12 can be lifted off base 11.

In the locked position, tongue 34 blocks switch 22 (a portion of which is shown in broken lines in FIG. 4) so that switch 22 cannot be moved or operated. The locked position may be important as a Sabbath mode of operation. In the locked position, since the receptacle 12 cannot be lifted off base 11, the heating elements of receptacle 12 and the electronic components of base 11 are not exposed and switch 22 cannot be operated, which eliminates the possibility of Sabbath desecration. Thus, the invention provides a Sabbath mode of operation not possible with the prior art.

What is claimed is:

1. A kettle comprising:
a receptacle for holding therein a liquid, a handle, a cover and a spout;
an electrical heating device configured to heat liquid in said receptacle;
a switch for operating said electrical heating device;
a controller in electrical communication with said electrical heating device and said switch, said controller cooperating with a temperature sensor to control a temperature of the liquid;
an electric base that comprises electrical components that are in electrical connection with said electrical heating device for providing electrical power to said electrical heating device for heating the liquid; and
a locking device located on said receptacle and movable between an unlocked position and a locked position to lock and unlock said receptacle to and from said base.

2. The kettle according to claim 1, wherein said locking device is separate from said electrical connection between said receptacle and said base.

3. The kettle according to claim 1, wherein said locking device is mechanical.

4. The kettle according to claim 1, wherein said locking device comprises a tongue that extends from a toggle handle, said toggle handle being arranged to slide or move in a slot formed in said receptacle.

5. The kettle according to claim 4, wherein said tongue is arranged to move in or out of locking engagement with said switch.

6. The kettle according to claim 4, wherein said toggle handle is movable between ends of said slot so as to move between the locked and unlocked positions.

7. The kettle according to claim 1, comprising a Sabbath mode of operation wherein said receptacle is in the locked position and cannot be lifted off said base and heating elements of said receptacle and said electronic components of said base are not exposed and said switch cannot be operated.

8. A method of using a kettle comprising:
providing a kettle that comprises:
a receptacle for holding therein a liquid, a handle, a cover and a spout;
an electrical heating device configured to heat liquid in said receptacle;
a switch for operating said electrical heating device;
a controller in electrical communication with said electrical heating device and said switch, said controller cooperating with a temperature sensor to control a temperature of the liquid;
an electric base that comprises electrical components that are in electrical connection with said electrical heating device for providing electrical power to said electrical heating device for heating the liquid; and
a locking device located on said receptacle and movable between an unlocked position and a locked position to lock and unlock said receptacle to and from said base; and
using the kettle in a Sabbath mode of operation wherein said receptacle is in the locked position and cannot be lifted off said base and heating elements of said receptacle and said electronic components of said base are not exposed and said switch cannot be operated.
